(19) United States
(12) Patent Application Publication
(10) Pub. No.: US 2010/0225449 A1
(43) Pub. Date: Sep. 9, 2010

(54) Radio-Frequency Surface-Acoustic-Wave Identification Tag and System

(75) Inventor: Clinton S. Hartmann, Dallas, TX (US)

Correspondence Address: DEMONT & BREYER, LLC, 100 COMMONS WAY, Ste. 250, HOLMDEL, NJ, 07733, US

(73) Assignee: RF SAW, INC., Richardson, TX (US)

(21) Appl. No.: 12/718,966

(22) Filed: Mar. 6, 2010

Related U.S. Application Data
(60) Provisional application No. 61/209,393, filed on Mar. 6, 2009.
(60) Provisional application No. 61/209,438, filed on Mar. 6, 2009.
(60) Provisional application No. 61/311,309, filed on Mar. 6, 2010.

(51) Int. Cl. H04Q 5/22

(52) U.S. Cl. 340/10.4

(57) ABSTRACT

A method of fabricating batches of linear RFID devices is disclosed. For example, the illustrative embodiments of the present invention provide a method for producing a batch of linear RFID devices that are advantageous in that they are less likely to be confused with each other than batches of similar devices in the prior art. Because the purpose of RFID devices is to identify something properly and accurately, anything that reduces the likelihood of misidentification is beneficial.

### CROSS REFERENCE TO RELATED APPLICATIONS

This application claims the benefit of, and incorporates by reference, U.S. Patent Application Ser. No. 61/209,393, filed 6 Mar. 2009.

This application claims the benefit of, and incorporates by reference, U.S. Patent Application Ser. No. 61/209,438, filed 6 Mar. 2009.

This application claims the benefit of, and incorporates by reference, U.S. Patent Application Ser. No. 61/311,309, filed 6 Mar. 2010.

### FIELD OF THE INVENTION

The present invention relates to radio communication in general, and, more particularly, to error-tolerant analog communication.

### BACKGROUND OF THE INVENTION

Radio-Frequency Identification (RFID) systems are a class of wireless remote-sensing systems. RFID systems are typically based on radio links between a plurality of sensing devices (often referred to as “tags”) and a reader unit that collects information from the sensing devices. In their simplest implementations, RFID tags report just their own presence, generally conveyed as an identification code unique to that tag. For example, such RFID tags could be used to replace bar codes commonly used in stores to identify items of merchandise. More advanced RFID tags can include sensors such as, for example, temperature, pressure, chemical and other environmental sensors. Such more advanced tags use the radio link to convey the value of the sensed parameter to the reader unit.

FIG. 1 depicts Radio-Frequency Identification System 100, which is an example of an RFID system in which tags report only their own presence. Radio-Frequency Identification System 100 comprises Radio-Frequency Identification Reader Unit 101 (hereinafter the “reader”) and Radio-Frequency Identification Tags 102-1 through 102-4.

The reader has an antenna capable of both transmitting and receiving radio signals. Radio-Frequency Identification Tags 102-1 through 102-4 are also equipped with an antenna capable of both transmitting and receiving. In order to detect the presence of the tags, the reader transmits a radio signal (hereinafter referred to as the “interrogation signal”) that is received by the tags. Each of the tags processes the received interrogation signal and responds by transmitting another radio signal (hereinafter referred to as the “response signal”).

The reader receives all the response signals from all the tags that are able to respond, and it must be able to discriminate the various received response signals from one another so as to successfully detect the identification codes of the tags that are transmitting. Such capability depends on several factors, for example, such factors include:
i. the signal structure;
ii. the information encoding scheme;
iii. the amount of information in each tag signal (i.e., the number of bits of information in the tag's message);
iv. the strength (energy) of the signals transmitted by the tags;
v. the distance between the tags and the reader;
vi. the amount and type of interference present in the environment;
vii. the detection scheme used by the reader;
viii. the number of tags that transmit simultaneously;
ix. the dynamic range of tag signals (i.e., the range of signal strengths between the strongest tag signal received by the reader and the weakest tag signal that the reader is required to detect;
x. distortion caused by the signal propagation environment; and
xi. other factors not explicitly listed here.

In many RFID systems it is important to have tags that are small, simple, and inexpensive. As a result, a technique known as “backscatter radio” is frequently used. In the American Heritage Dictionary, the word “backscatter” is defined as: “The deflection of waves . . . by electromagnetic . . . forces through angles greater than 90° to the initial direction of travel.” Hereinafter, “backscatter radio” refers to the technique of receiving a radio signal and then transmitting the same radio signal after some processing. This is in contrast to more traditional two-way radio communications wherein a device for transmitting and receiving radio signals (hereinafter referred to as a “transceiver”) comprises (1) a radio receiver that detects and demodulates a received radio signal to extract the information it carries; and (2) a radio transmitter that generates a new radio signal with the desired modulation and then transmits that signal through a transmitting antenna.

Backscatter-radio techniques lead to simple implementations because a backscatter radio transceiver does not need to have hardware (such as, for example, an oscillator or a power amplifier) for generating a radio signal. Furthermore, in systems such as the one depicted in FIG. 1, the tags only report their own presence and, therefore, do not need to receive any information from the reader. In this case, even the need for receiver hardware is avoided.

Several backscatter-radio techniques exist. The present invention is based on a technique hereinafter referred to as “linear backscatter.” In a system that utilizes linear backscatter, the tags behave as linear filters. Linear filters are well known in the art as devices whose outputs are linear functions of their inputs. In particular, RFID tags in accordance with the present invention have a single port that is used for both input and output (hereinafter referred to as “input-output port”). When an input signal is applied to the input-output port, an output signal is delivered from the input-output port that is based on the input signal and is a linear function of it. As such, the signal processing that occurs in the tag is known in the art as linear filtering.

Even though the mathematical definition of linear filtering allows for an output signal that begins before the input signal is applied, the real world requires that physical linear filters obey causality and, in practice, there is a delay between the application of the input signal and the resulting output signal. Indeed, as will be discussed in more detailed later, a certain amount of delay is desirable for avoiding the distortion caused by the signal propagation environment.

In most radio environments of practical interest, radio signals propagate from transmitting antenna to receiving antenna through a propagation medium that is known to be very closely linear. Therefore, in an RFID system as depicted in FIG. 1 wherein the tags are linear-backscatter tags there is a linear relationship between the interrogation signal and the response signal. In particular, the response signal is generated from the interrogation signal as follows:
i. The interrogation signal is converted to a radio signal by the transmitting antenna of the reader and it is transmitted into the radio propagation medium. Antennas are known in the art to be linear devices.
ii. The interrogation signal, transmitted as a radio signal, propagates through the linear radio propagation medium to the antennas of RFID tags 102-1 through 102-4.
iii. Each tag antenna receives the interrogation signal, converts it to an electrical signal, and delivers it to the input-output port of the tag as an input signal. Again, antennas are known in the art to be linear devices.
iv. After a delay, a response signal comes out of the input-output port as an output electrical signal. The response signal is a linear function of the input signal.
v. The tag antenna converts the electrical output response signal into a radio signal and transmits it into the radio propagation medium.
vi. The transmitted radio response signal propagates through the linear radio propagation medium to the receiving antenna of RFID reader unit 101. (Note: the reader might have separate antennas for transmitting and receiving, or it might have a single antenna for both functions).
vii. The receiving antenna of the reader receives the response signals from all the tags; it is well known in the art that, when an antenna receives multiple signals simultaneously, the signals are combined linearly and the resulting combined signal is converted to a single electrical signal.
viii. The combined electrical signal is processed by the reader.

It is well known in the art that, when linear filters are cascaded and combined as described in the list above, the overall cascade is also a linear filter. It is also well known in the art that a linear filter is entirely characterized by its “impulse response.” The impulse response of a linear filter is the output that the filter produces when the input is a narrow pulse.

In order to estimate the impulse response of a linear filter it is not necessary to actually apply a narrow pulse to the input of the filter. Several techniques are well known in the art to empirically estimate the impulse response of a linear filter by applying inputs to it that differ from a narrow pulse. However, it is convenient to describe linear filters in terms of their impulse response. Accordingly, hereinafter the operation of linear-backscatter RFID systems will be described as follows:
i. RFID reader unit 101 transmits a narrow pulse of a radio-frequency signal out of its transmitting antenna.
ii. RFID reader unit 101 receives an impulse response through its receiving antenna.
iii. RFID reader unit 101 processes the received impulse response to detect the individual impulse responses of tags 102-1 through 102-4.
   It will be clear to those skilled in the art that the impulse response received in step iii can also be obtained by transmitting signals other than a narrow pulse, with appropriate processing in the reader. For example, and without limitation, the transmitted signal can be:
i. a chirped waveform,
ii. a pseudo-random waveform,
iii. a set of discrete tones, or
iv. other signals.

FIG. 2 illustrates what happens in response to the transmission of a narrow pulse by RFID reader unit 101. The top half of the figure shows narrow transmitted pulse 210 as transmitted by the reader. The bottom half shows the impulse response received by the reader as a result of transmitting pulse 210.

In the illustrative example of FIG. 2, the received impulse response is comprised of two parts: (a) backscatter clutter 220 caused by the propagation environment; and (b) the response signal 230 from one of the tags. Part (a), the backscatter clutter, is caused by objects in the environment such as furniture, walls, people, etc. Any object that is capable of reflecting radio waves will send a reflection of pulse 210 back to the reader's receiving antenna after a delay. Such unwanted reflections are collectively known as “clutter” in the art.

The delay of clutter reflections is due to the finite speed of radio waves (the same as the speed of light). The delay is proportional to the round-trip distance between the reader and the object causing the reflection. The speed of light is, approximately, 30 cm (about one foot) per nanosecond; so, for example, an object situated at a distance of 6 m from the reader will add a pulse to the clutter approximately 40 ns after the transmission of pulse 210.

Clutter components may arise from multiple reflections, a phenomenon known as multipath-propagation that is a well-known cause of signal distortion for indoor radio systems. Although multiple reflections can cause clutter components to occur at delays longer than the round-trip delay to reflecting objects in the environment, all clutter components become progressively weaker with distance traveled. Therefore, after a certain amount of time, clutter becomes vanishingly small.

In the illustrative example of FIG. 2, the response signal begins after a delay of 1 μs from the transmitted pulse 210. A delay of 1 μs corresponds to a propagation distance of 300 m. If tags 102-1 through 102-4 are at a distance of, for example, 6 m from the reader, their response signals have to travel only 12 m, round trip, to return to the reader, while any clutter component that overlaps the beginning of the response signal has had to travel 300 m. Even though the response signals from the tags may be weak, due to the small size of the tags and due to losses in the tag's linear filter, it is likely that any clutter components that have traveled 300 m will be extremely weak and, therefore, not interfere with reception of the response signals by the reader.

FIG. 3 depicts an illustrative example of a linear device that can be used to make RFID tags for a linear-backscatter RFID system. Linear RFID device 300 is a piezoelectric Surface Acoustic Wave (SAW) device. It comprises a piezoelectric substrate 301, an input-output port 303 which, in turn, comprises electric contacts 303-1 and 303-2, a transducer 304, and a template comprising a plurality of reflector patterns, 302-1 through 302-32, represented by dashed lines that run across the surface of the substrate. The device is advantageous because it allows the low-cost manufacture of large quantities of RFID tags that differ from one another in the response signals that they generate.

An input signal applied to the input-output port 303 is converted, by transducer 304, into an acoustic wave that travels on the surface of the piezoelectric substrate. The conversion is linear, and the propagation of the wave is also linear. The surface wave travels from left to right.

The template for manufacturing an individual device comprises patterns for 32 reflectors, 302-1 through 302-32, each of which is capable of reflecting a portion of the incident wave back toward the transducer. However, as part of the manufacturing process, most of the patterns are deleted. The ones that are not deleted result in actual reflectors that are placed on the surface of the piezoelectric substrate.

FIG. 4 depicts an illustrative example of two actual manufactured devices wherein only four actual reflectors are placed on the surface of the piezoelectric substrate. The actual reflectors are represented by heavy black lines that run across the surface of the substrate. The dashed lines represent the positions of the other 28 reflector pattern that were deleted as part of the manufacturing process. The 32 pattern positions, 302-1 through 302-32, are referred to as “possible” positions.

In the illustrative example of FIG. 4, the two manufactured devices shown differ from one another in only one position: device 401-1 has an actual reflector at position 17, while device 401-2 has, instead, an actual reflector at position 18.

SAW devices are advantageous because the speed of propagation of the surface acoustic wave is about five orders of magnitude smaller than the speed of light. Accordingly, to achieve a delay of 1 μs, a traveled distance of about 3 mm is sufficient, instead of 300 m. So, for example, the illustrative impulse response of FIG. 2, which comprises four reflected pulses beginning at a delay of 1 μs, can be realized with four actual reflectors wherein the first actual reflector is at a position approximately 1.5 mm from the transducer 304. The round trip from the transducer to the first reflector and back then lasts approximately 1 μs and the reflection from the first reflector generates the first pulse in the impulse response of FIG. 2.

Although FIG. 2 depicts a device with 32 possible reflector positions, it will be clear to those skilled in the art how to make and use devices that have a different number of possible reflector positions. It will also be clear to those skilled in the art how to make and use manufactured devices wherein the number of actual reflectors is different from four. Additionally, it will be clear to those skilled in the art how to make and use devices wherein the possible reflector positions are grouped into discrete groups. For example, it is possible to make a device with two or more groups of 32 possible positions wherein each group comprises the same number of actual reflectors in a manufactured device.

The duration (also referred to as “width”) of a narrow pulse of a radio-frequency signal depends on the signal's bandwidth. Generally, radio transmissions are regulated by national and international standards, and bandwidth is usually available in narrow bands and at frequencies that are assigned by regulating bodies. For example, in the United States, the band where WiFi systems operate has a center frequency of about 2.438 GHz and a bandwidth of about 70 MHz subdivided into channels of about 22 MHz each. Accordingly, an RFID system operating in this band will be able to transmit pulses with a bandwidth of, at most, 70 MHz. If the RFID system needs to share the band with other systems (for example, with a WiFi system) then the bandwidth available to the RFID system will be even less.

The width of a band-limited pulse cannot be less than, approximately, the inverse of the available bandwidth. So, for example, a pulse limited to a maximum bandwidth of 70 MHz must be longer than about 14 ns. In contrast, in the SAW devices of FIGS. 3 and 4, the separation between adjacent possible reflector positions can be much less; for example, it can be 3 ns.

FIG. 5 illustrates why narrow-band pulses are a problem for the reader when it attempts to discriminate response signals from different RFID tags. The Figure depicts the first three pulses of the response signal as generated by manufactured devices 401-1 and 401-2. in particular, the top half of FIG. 5 depicts pulses 520-1, 520-2 and 520-3, as generated by device 401-1, and the bottom half of FIG. 5 depicts pulses 530-1, 530-2 and 530-3, as generated by device 401-3. The pulses are depicted as having a non-negligible width, as due to a bandwidth constraint as set forth above.

In accordance with the depiction of actual reflectors shown in FIG. 4, pulse 520-1 occurs at the same time as pulse 530-1, and pulse 520-2 occurs at the same time as pulse 530-2; also, pulse 520-3 occurs earlier than pulse 530-3 by time interval 540, which is denoted as “pulse step” in FIG. 5. The duration of pulse step 540 corresponds to the additional travel time of the surface acoustic wave as it is reflected by an actual reflector at position 18 in device 401-2, as opposed to position 17 in device 401-1. The fourth pulse in the response signal is not explicitly shown but, in accordance with FIG. 4, it occurs at the same time for both devices. Therefore, the two pulse patterns differ, from one another, only in the position of the third pulse; and the difference amounts to a shift, in the pulse position, that is a fraction of the pulse width.

The receiver in the reader must be able to discriminate between the two pulse patterns depicted in FIG. 5 in order to correctly identify which of the devices, if any, is present. It is well known in the art that the ability to discriminate between waveforms is a function of the “euclidean distance” between the waveforms. In particular, if we denote the two pulse-pattern waveforms of FIG. 5 as y1(t) and y2(t), the euclidean distance between them is defined as:

d12=\sqrt{∫[y1(t)−y2(t)]²dt}. (1)

In the case of FIG. 5, the first, second and fourth pulse occur at the same time and are, therefore, identical. Because of this, their contribution to the distance, as defined in equation (1), is zero. It is only the small change in the position of the third pulse that makes the distance d12 non-zero.

It is well known in the art that the euclidean distance between two waveforms is related to the signal-to-noise ratio (SNR) required to discriminate between them. In particular, in a communication system that must discriminate among a plurality of waveforms, it is the minimum distance between any two waveforms that determines the required SNR, which decreases as the inverse of the square of the minimum distance. Therefore, it is a goal of the RFID system of FIG. 1 to achieve a large distance between the waveforms of response signals from different RFID devices.

It is well known in the art that waveforms such as y1(t) and y2(t) are part of a Hilbert space that comprises all the possible waveforms that can be received as response signals by the reader. It is also well known in the art that a technique known as “match filtering” can be used to detect the waveforms and discriminate between them, as long as all nominal waveforms have the same energy. Mathematically, detection through match filtering is accomplished by computing a plurality of inner products between a received waveform, r(t), and the nominal transmitted waveforms know a priori: to detect the presence of one of the two waveforms, y1(t) and y2(t), in the received signal, r(t), the reader computes two inner products:

(r(t),y1(t))=∫r(t)·y1(t)dt, (2)

(r(t),y2(t))=∫r(t)·y2(t)dt;

and compares the larger of the two to a threshold in order to decide which waveform is present. Thus, the ability to discriminate between the two waveforms is a function of the inner product between them; the larger the inner product, the harder it is to discriminate between two waveforms. It is well known in the art, and it is easy to show, that the inner product between two waveforms is a monotonically decreasing function of the euclidean distance between them. Therefore, maximizing the distance between two waveforms is equivalent to minimizing their inner product.

FIG. 6 illustrates a technique in the prior art for increasing the distance between the pulse patterns produced by devices 401-1 and 401-2. The technique is based on the fact that band-limited radio-frequency pulses are characterized by both an amplitude and a phase. Although not explicitly stated earlier, FIG. 5 shows the amplitude of pulses as a function of time. For a complete representation, both amplitude and phase need to be shown; equivalently, amplitude and phase of a radio-frequency signal can be represented in terms of two orthogonal dimensions known in the art as “in-phase” and “quadrature”.

FIG. 6 depicts such a two-dimensional representation by showing not one, but two axes orthogonal to the time axis, one for the in-phase dimension and the other one for the quadrature dimension. The position of each pulse relative to these axes is emphasized by the straight lines depicted inside each pulse to show the plane of the pulse.

According to the two-dimensional representation of band-limited radio-frequency signals, each signal is represented not by one, but by two waveforms, one for the in-phase dimension and one for the quadrature dimension. The formula for the Euclidean distance given in equation (1) can be applied to either dimension, and the total euclidean distance between two band-limited radio-frequency signals is defined as

d12total=\sqrt{d12inphase²+d12quad²}, (3)

wherein d12inphase and d12quad are the euclidean distances between the two in-phase waveforms and between the two quadrature waveforms of the two signals, respectively.

Thanks to the additional dimension, it is possible to achieve good distance between pulse even if the timing difference between them is small. The phase of a pulse is the angle of the pulse signal in the in-phase-quadrature plane. FIG. 6 shows that the plane of pulse 630-3 is disposed at an angle of approximately 60° relative to the plane of pulse 620-3. Therefore, even though the amplitudes of the two pulses are, relative to one another, the same as for pulses 520-3 and 530-3, the euclidean distance between the 620-3 and 630-3 pulses is much greater.

In the design of linear RFID device 300, the phase of a pulse reflected by an actual reflector can be adjusted independently of the delay of the pulse by adjusting the corresponding reflector pattern in the template in a manner that is well known in the art. Indeed, in the prior art, reflector patterns 302-1 through 302-32 are adjusted such that the phase of reflected pulses changes, from one reflector pattern to the next, by a pre-determined step. For example, the step can be 60°, as illustrated in FIG. 6.

FIG. 7 is a graph that shows the advantageous effect of changing the phase of reflected pulses from one reflector pattern to the next. It plots the euclidean distance between reflected pulses as a function of difference in the positions of the associated reflector patterns in the template of RFID device 300. Curve 710 shows how the distance between reflected pulses increases as a function of reflector position for the case where the phase step between consecutive reflector patterns is zero. The figure is for pulses with a bandwidth of 30 MHz, and reflector patterns for which the spacing between consecutive patterns corresponds to delay difference of 3 ns. The distance is normalized by assuming a pulse energy of one. It is easy to verify from equations (1) and (3) that two widely separated pulses have a distance of \sqrt{2}. Indeed, both curves in FIG. 7 appear to converge to that value as the difference in position sown on the horizontal axis becomes large.

The width of a 30-MHz pulse is approximately 33 ns, which is 11 times the delay increment between consecutive reflector patterns; therefore, curve 710 shows that the distance increases slowly as a function of separation between reflector patterns, as the two pulses being compared are, at first, very similar to one another. In contrast, curve 720, which shows the case wherein the phase step between consecutive reflector patterns is 60°, rises very steeply because of the phase difference between the pulses. Note that curve 720 intersects curve 710 at points that are multiples of 6 because, at those points, the accumulated phase change is 60°·6=360°, and there is no phase difference between the two pulses.

FIG. 8 is a graph similar to the graph of FIG. 7, but calculated for a pulse bandwidth of 60 MHz. Both curves can be observed to rise more steeply, and the advantage of the phase step can be observed to be substantial even in this case.

FIGS. 7 and 8 show that it is possible to achieve a minimum distance as large as approximately unity between different pulse patterns even in the presence of band limiting. However, an even larger minimum distance would be advantageous in many RFID systems where such enhanced distance would provide additional immunity from noise and interference and would also enhance the system's ability to detect multiple overlapping response signals.

Heretofore, phase difference between pulses has been expressed as a phase angle measured in degrees. For band-limited waveforms, it is also possible to express phase difference as a “phase delay.” Hereinafter, phase delay will be used to express phase difference wherever advantageous for added clarity. It is well known in the art how to convert from phase difference to phase delay and vice versa for band-limited waveforms. Also, heretofore the term “delay” has been used without qualification to mean “group delay” as is customary in the art. Hereinafter, wherever advantageous for added clarity, the distinction between group delay and phase will be made explicit. The distinction between group delay and phase delay is well known in the art.

### SUMMARY OF THE INVENTION

The present invention enables the fabrication of batches of linear RFID devices without some of the costs and disadvantages of RFID devices in the prior art. For example, the illustrative embodiments of the present invention provide a method for producing a batch of linear RFID devices that are advantageous in that they are less likely to be confused with each other than batches of similar devices in the prior art. Because the purpose of RFID devices is to identify something properly and accurately, anything that reduces the likelihood of misidentification is beneficial.

RFID devices fabricated in accordance with the present invention are less likely to be confused with each other because the phase and amplitude of the signal transmitted from each device is guaranteed to be “sufficiently dissimilar” from the phase and amplitude of the signal transmitted from every other device in the batch. This criterion is more restrictive than merely requiring that each signal is different—which is the sine qua non of RFID devices.

The sufficient dissimilarity of the signals is achieved by cleverly positioning the reflectors on the RFID according to one or more “rules”—such as those described in detail below. Furthermore, the minimum amount dissimilarily—or “distance” as used in information theory—can be adjusted to affect the likelihood of confusion between any two RFID devices in a batch.

### BRIEF DESCRIPTION OF THE DRAWINGS

FIG. 1 depicts Radio-Frequency Identification System 100, which is an example of an RFID system in which tags report only their own presence.

FIG. 2 illustrates what happens in response to the transmission of a narrow pulse by RFID reader unit 101.

FIG. 3 depicts an illustrative example of a linear device that can be used to make RFID tags for a linear-backscatter RFID system.

FIG. 4 depicts an illustrative example of two actual manufactured devices wherein only four actual reflectors are placed on the surface of the piezoelectric substrate.

FIG. 5 illustrates why narrow-band pulses are a problem for the reader when it attempts to discriminate response signals from different RFID tags.

FIG. 6 illustrates a technique in the prior art for increasing the distance between the pulse patterns produced by devices 401-1 and 401-2.

FIG. 7 is a graph that shows the advantageous effect of changing the phase of reflected pulses from one reflector pattern to the next.

FIG. 8 is a graph similar to the graph of FIG. 7, but calculated for a pulse bandwidth of 60 MHz.

FIG. 9 depicts the performance of a first illustrative embodiment of the present invention.

FIG. 10 depicts a flowchart of the salient tasks performed by the first illustrative embodiment of the present invention.

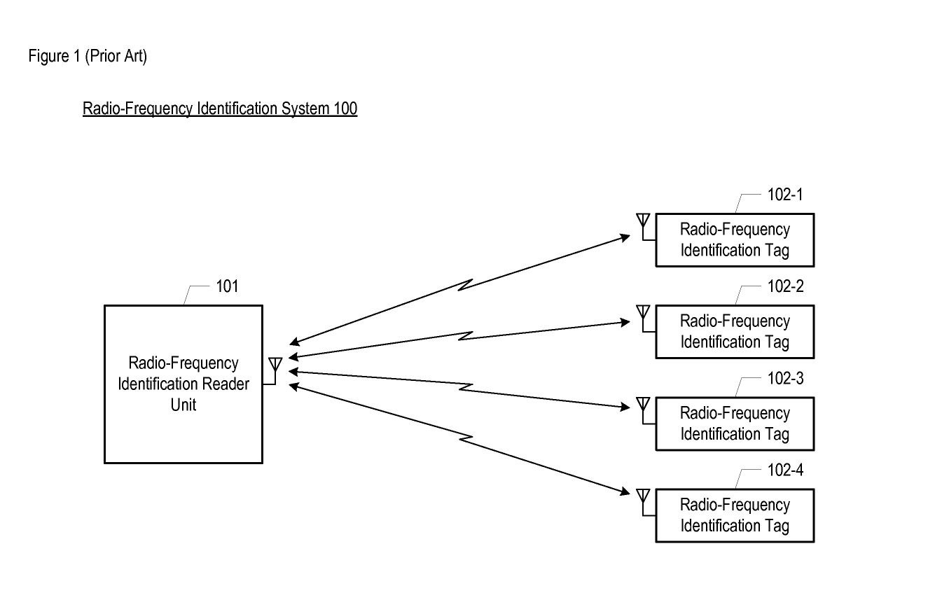

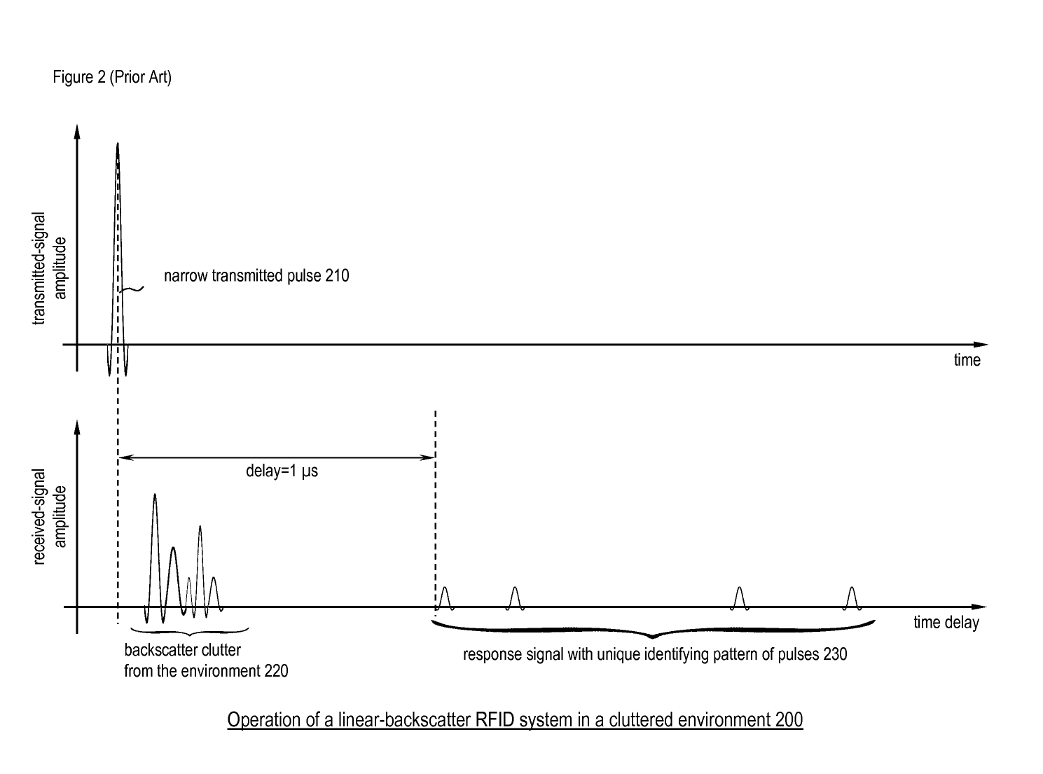

### DETAILED DESCRIPTION

In contrast to prior-art manufactured RFID devices 401-1 and 402-2 whose patterns of actual reflectors differ by only one position, RFID devices manufactured in accordance with the present invention have patterns of actual reflectors that differ by more than one position. In particular the present invention allows the manufacture of devices that are guaranteed to differ in at least two positions.

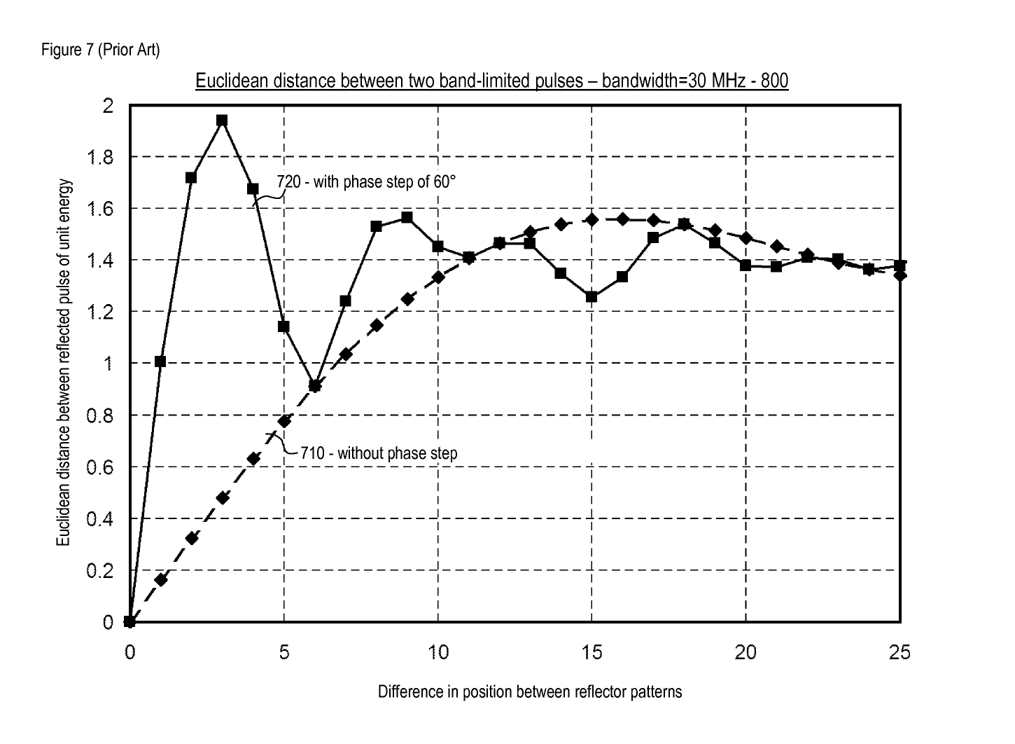

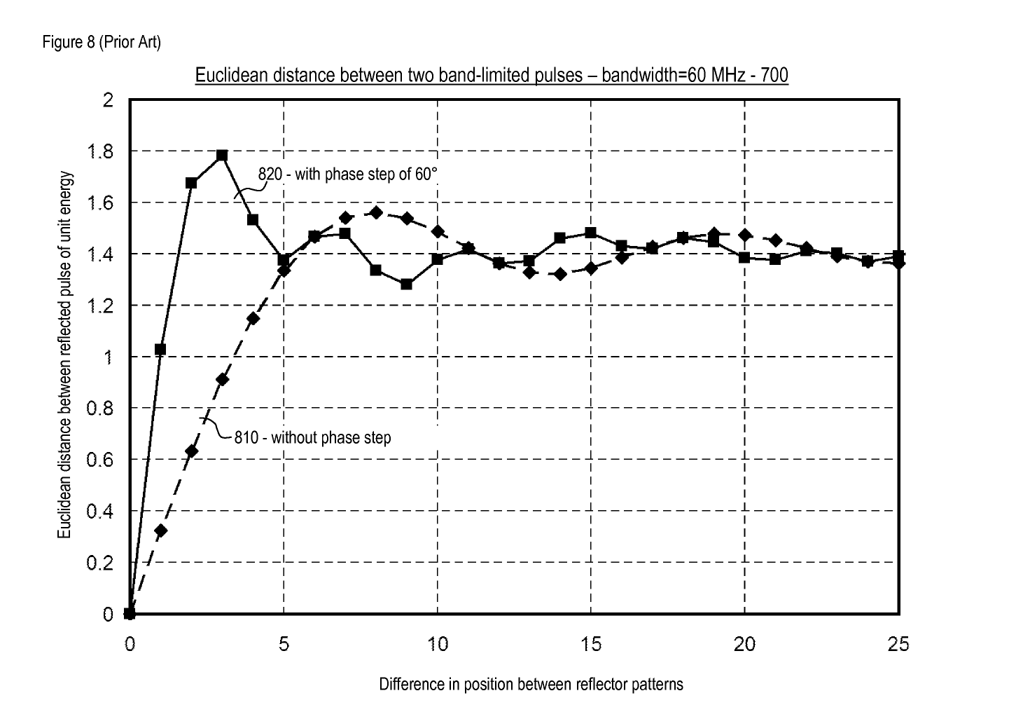

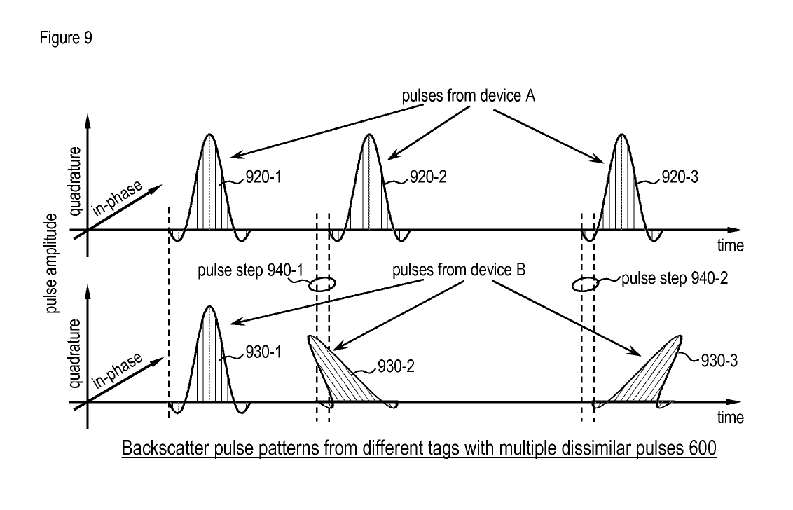

FIG. 9 depicts the performance of a first illustrative embodiment of the present invention. The figure depicts two patterns of three pulses each, one pattern for each of two possible manufactured RFID devices identified as device A and device B. Pulse 920-3 is identical to pulse 620-3 and pulse 930-3 is identical to pulse 630-3 and, as in FIG. 6, the phase difference between these two pulses provides a substantial distance between the two pulse patterns, as illustrated in FIGS. 7 and 8. But, in contrast with the prior art, the two pulse patterns of FIG. 9 also differ in the second pulse. In particular, pulse 920-2 and pulse 930-2 are generated by actual reflectors at different possible positions; according to this illustrative embodiment, the two actual reflectors are at consecutive possible positions.

In this illustrative embodiment, there is a phase step of 60° between consecutive possible positions and, accordingly, pulse 930-2 is shown in FIG. 9 as having a phase difference of 60° with respect to pulse 920-2. The increased distance between pulse patterns that is provided by the presence the of two pairs of differing pulses, one pair being pulses 920-3 and 930-3, and the other pair being 920-2 and 930-2, can be calculated from equations (1) and (3) through mathematical manipulations well known in the art.

In order to achieve the desired multiple differences between pulse pairs, RFID devices in accordance with the present invention comprise only patterns of actual reflectors that meet certain constraints. In particular, the constraints are set forth as follows.

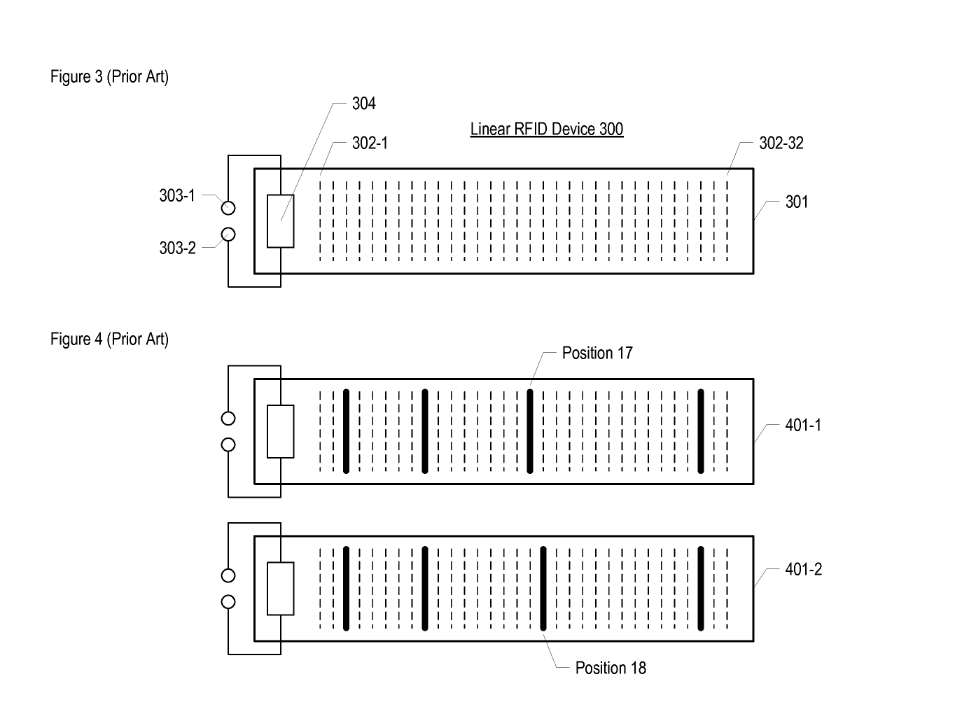

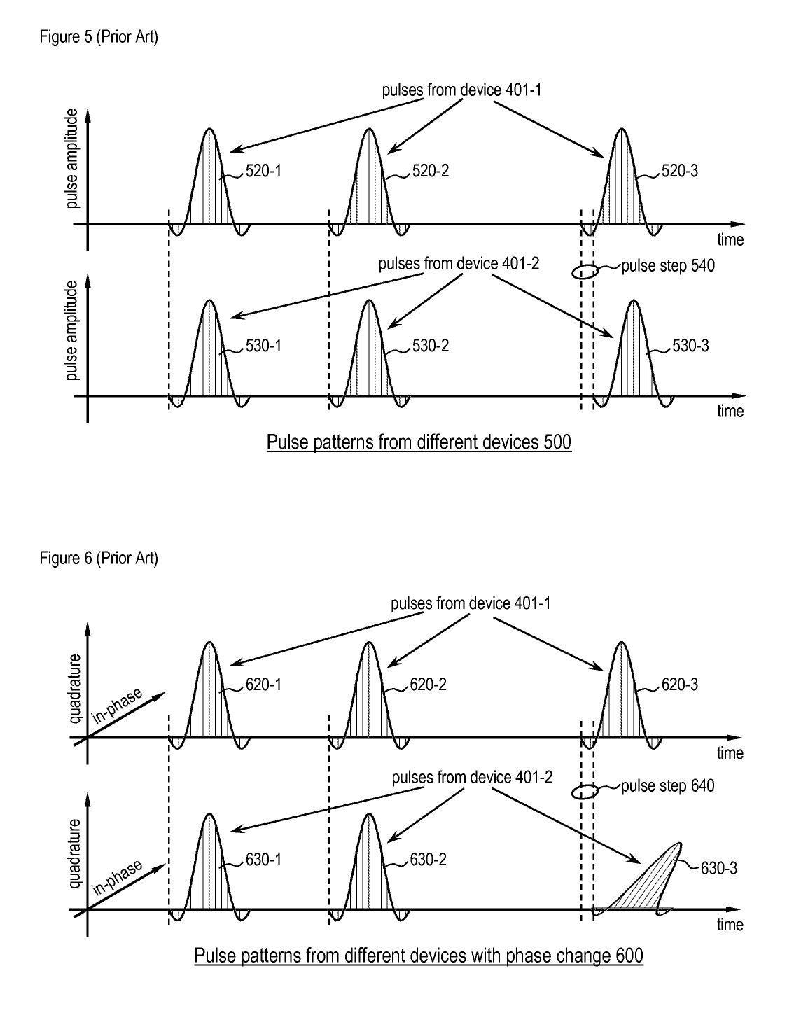

In order to express the constraints mathematically, it is advantageous to label the possible reflector positions with consecutive integers, starting with 1, in the order in which they occur in the RFID device, such that higher integers correspond to positions that yield larger group delays. For example, in RFID device 300 of FIG. 3, wherein the input signal travels from left to right through possible positions 302-1 through 302-32, in increasing sequence, the 32 possible positions can be labeled with integers from 1 to 32 in increasing order. With this labeling, a particular pattern of N actual reflectors can be represented as a sequence of N integers, wherein N itself is a positive integer not greater than the number of available positions, denoted as M, which is also a positive integer. In embodiments of the present inventions, N must be strictly less than M.

The N actual reflectors can also be separately labeled with consecutive integers running from 1 to N also in the order in which they occur in the RFID device, such that higher integers correspond to positions that yield larger group delays. In particular, hereinafter the symbol h will be used to denote integers that identify one of the M possible positions, and the symbols m and n will be used to denote integers that identify one of the N actual reflectors. In particular, the function h(n) will be used to denote the sequence number of the possible position where n-th actual reflector is actually placed. With these labelings, the group delay of the pulse reflected by actual reflector n can be expressed as a function, D(h(n)), that is a monotonically increasing function of h.

in an RFID system in accordance with the present invention, RFID devices have M possible reflector positions, of which N are occupied by actual reflectors. The positions of actual reflectors are denoted, for each RFID device, by the N integer values h(1), . . . , h(N). For each RFID device the following constraints must be satisfied:

(a) Each of the N−1 separations between adjacent reflected signals, defined as h(m+1)−h(m) and denoted as Δ(m), must be expressible as the sum of a base value, Δ0(m), and an integer multiple of a position step, Δstep, common to all separations; i.e., each separation must be expressible as Δ(m)=Δ0(m)+Δinc(m)·Δstep, wherein m is an integer in the range [1, . . . , N−1], and

(b) wherein Δ0(m) is a positive integer that defines the minimum allowed value of separation Δ(m), and

(c) wherein Δstep is a positive integer greater than one that defines the increment by which separation Δ(m) can be increased, and

(d) wherein Δinc(m) is a non-negative integer.

It is well known in the art that there are

$$( \begin{matrix}M \\ N\end{matrix} )$$

possible configurations of N actual reflectors among M possible positions, wherein

$$( \begin{matrix}M \\ N\end{matrix} )$$

is known in the art as a binomial coefficient. Only a subset of the

$$( \begin{matrix}M \\ N\end{matrix} )$$

such patterns satisfy constraints (a) through (d). An RFID system in accordance with the present invention has RFID devices whose pattern of actual reflectors come from that subset. The subset is not unique, as it is defined by a particular choice of the values Δstep, and Δ0(1), . . . , Δ0(N−1).

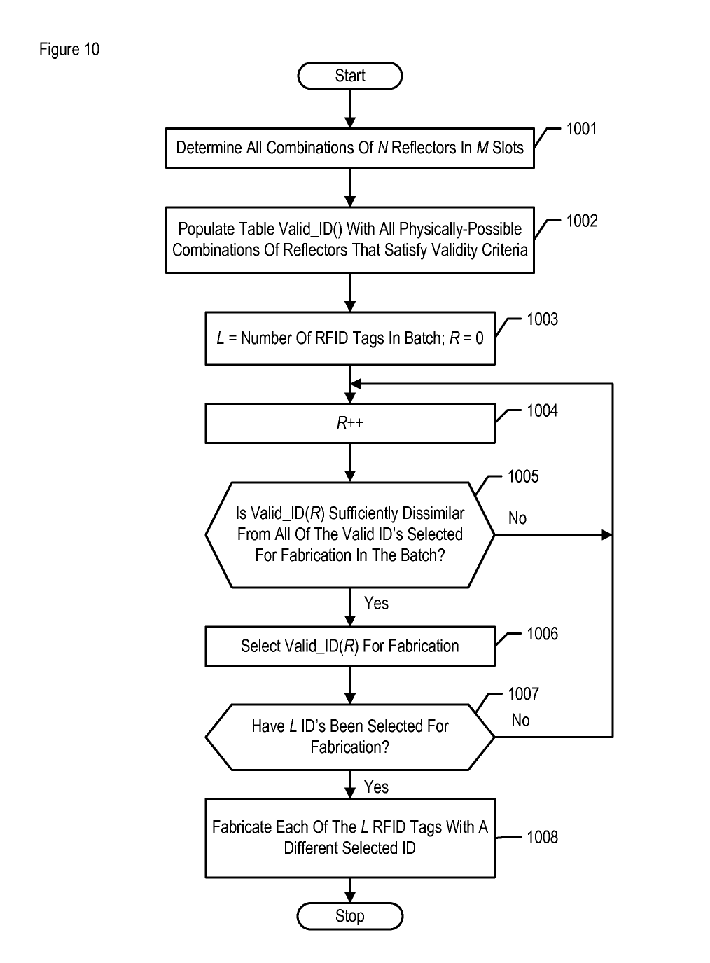

FIG. 10 depicts a flowchart of the salient tasks performed in accordance with the first illustrative embodiment of the present invention.

Note that the ID's of any two RFID tags are, by definition, different. But that does not imply that any ID is equally advantageous in an RFID tag as any other ID.

When the number of distinct RFID tags that can be fabricated is large and a relatively small batch of tags is to be fabricated and used together, it is advantageous to select the ID's of the tags in the batch so that they are more “dissimilar” from each other than tags with sequentially or randomly selected ID's. The reason is that by carefully selecting which ID's are used in a batch, one can reduce the likelihood that any two ID's in the batch will be confused with each other.

As a greatly-simplified example, suppose that a printed label can comprise an ID between 1 and 1,000,000, and a batch of 100 labels is to be printed and used together. Although it might be simple to print the labels with the ID's 1 through 100, the fact that some numbers look similar—at least psycho-visually—increases the likelihood that the ID on one label will be confused with another ID. For example, on casual examination, the ID “89” can be easily confused with ID's “88,” “98,” or “99.”

In general, one way to reduce the likelihood of confusion is to ensure that each ID on each label is “sufficiently dissimilar” than the other ID's in the batch. For example, the 100 ID's might be chosen so that no two ID's can have the same digit in the same position. Therefore, if use of ID “89” would preclude the use of any other ID with an “8” in the ten's column or a “9” in the one's column, and thus there would not also be an ID “88” or “99.”

In the example of printed labels, the similarity of ID's is largely an issue of psycho-visual similarity. In RFID tags, the similarity of ID's is a function of the modulation of the radio-frequency signals that the tags transmit. This includes the frequency, phase, and amplitude of the signals. Therefore, in accordance with the illustrative embodiments of the present invention, the dissimilarity of ID's is measured by the distance—in the information theory sense—of the backscatter patterns of the ID's, which is a function of the absolute and relative positions of the actual reflectors on the RFID tag.

Referring to FIG. 10, at task 1001, list all

$$( \begin{matrix}M \\ N\end{matrix} )$$

patterns of N reflectors in M possible positions.

At task 1002, choose values for Δstep, and Δ0(1), . . . , Δ0(N−1) and create a table of patterns Valid_ID( ) which is a subset of the

$$( \begin{matrix}M \\ N\end{matrix} )$$

patterns, that satisfy the constraints (a) through (d) listed above.

At task 1003, the number of RFID tags to be fabricated in a batch is determined and assigned to the variable L, and a counting the variable R is initialized to zero (0).

At task 1004, the variable R is incremented by one (1).

At task 1005, the test “is Valid ID(R) sufficiently dissimilar from all of the valid ID's selected for fabrication in the batch?” Upon the first occurrence of task 1005, there have been no valid ID's selected for fabrication, and, therefore, Valid_ID(1) is sufficiently dissimilar and control passes to task 1006. Upon subsequent occurrences of task 1005, when the answer is “Yes,” control passes to task 1006; otherwise control passes to task 1004.

The function Valid_ID( ) is described below and in the accompanying figures.

In accordance with the illustrative embodiments, the test of “sufficiently dissimilar” is manifest by a rule expressed in terms of the absolute and relative positions of the reflectors on the tag.

In accordance with the first illustrative embodiment, the rule is that at least C of the positions of the N actual reflectors in each of the L radio-frequency (RFID) devices are different from the positions of the N actual reflectors in each of the other L−1 radio-frequency (RFID) devices, wherein C is a positive integer greater than one and N is a positive integer greater than or equal to C. In other words, of the N reflectors on two tags, at least C of them are in different positions. It will be clear to those skilled in the art, after reading this disclosure, how to make and use alternative embodiments of the present invention in which C has another value (e.g., C=3, C=4, C=5, C=6, etc.). As a practical matter, C is chosen as a function of L, M, and N because L, M, and N affect the number of ID's needed for the batch and the number of different ID's available.

It will be clear to those skilled in the art, after reading this disclosure, how to make and use alternative embodiments of the present invention in which the rule is that at least C of the positions of the N actual reflectors in each of the L radio-frequency (RFID) devices are at least Z positions away from the positions of the N actual reflectors in each of the other L−1 radio-frequency (RFID) devices, wherein C is a positive integer greater than one, N is a positive integer greater than or equal to C, and Z is a positive integer greater. In other words, of the N reflectors on two tags, at least C reflectors in each pair of RFID tags that are at least Z positions away from C reflectors on each other. It will be clear to those skilled in the art, after reading this disclosure, how to make and use alternative embodiments of the present invention in which C has another value (e.g., C=3, C=4, C=5, C=6, etc.). It will be clear to those skilled in the art, after reading this disclosure, how to make and use alternative embodiments of the present invention in which Z has another value (e.g., Z=2, Z=3, Z=4, Z=5, Z=6, etc.). As a practical matter, C and Z are chosen as a function of L, M, and N because L, M, and N affect the number of ID's needed for the batch and the number of different ID's available.

At task 1006, Valid ID(R) is selected as an ID for fabrication in the batch.

At task 1007, the test is whether enough ID's have been selected for each tag in the batch? When the answer is “Yes,” control passes to task 1007; otherwise control passes to task 1003.

At task 1008, the batch of L tags is fabricated, each with one of the selected ID's.

The method depicted in FIG. 10 can be used with any rule for “sufficiently dissimilar.” Appendix A is a C++ program for generating the positions of the reflectors (e.g., “pulses”) for valid ID tags in accordance with a second illustrative embodiment of the present invention.

It is to be understood that the disclosure teaches just one example of the illustrative embodiment and that many variations of the invention can easily be devised by those skilled in the art after reading this disclosure and that the scope of the present invention is to be determined by the following claims.

APPENDIX A
Program for Generating ID's With Four Reflectors at Positions H, I, J, & K in a Field
of 78 Possible Positions

1 // CreatePulsePositions( ) creates an array of h,i,j,k values.
2 // Note that to get H,I,J,K values
3 // H = h;
4 // I = i + 8;
5 // J = j + 8 + 10;
6 // K = k + 8 + 10 + 8;
7
8 unsigned int CreatePulsePositions(char PulsePositions[ ][4], const unsigned

| | int ArraySize) |
|---|---|
| 9 { | |
| 10 | const int kmax = 77; |
| 11 | unsigned int StateNo = 0; |
| 12 | for (int MABPass = 0; MABPass < 28; MABPass++) |
| 13 | { |

| | |
|---|---|
| 14 | for (int NScram = 0; (NScram < 22) && (StateNo < ArraySize); |

NScram++)

| | |
|---|---|
| 15 | { |

| | |
|---|---|
| 16 | unsigned int n = 2 * ((9 * NScram) % 22) + 19; |
| 17 | unsigned int Pn = (n − 5) >> 1; |
| 18 | unsigned int Test1 = int(float(Pn) / 56.0f + (MABPass − 1) |

* float(Pn) / 28.0f + 0.62f);

| | |
|---|---|
| 19 | unsigned int Test2 = int(float(Pn) / 56.0f + MABPass * |

float(Pn) / 28.0f + 0.62f);

| | |
|---|---|
| 20 | if (Test2 > Test1) |
| 21 | { |

| | |
|---|---|
| 22 | if ((Pn % 2) > 0) |

| | |
|---|---|
| 23 | ijskip = 4; |

| | |
|---|---|
| 24 | else |

| | |
|---|---|
| 25 | { |

| | |
|---|---|
| 26 | if ((Pn % 3) > 0) |

| | |
|---|---|
| 27 | ijskip = 3; |

| | |
|---|---|
| 28 | else |

| | |
|---|---|
| 29 | ijskip = 5; |

| | |
|---|---|
| 30 | } |
| 31 | unsigned int P0 = (((Test2 − 1) * ijskip) % Pn) |

+ 1;

| | |
|---|---|
| 32 | for (unsigned int cell = 0; (cell <= ((kmax − |

n) >> 1)) && (StateNo < ArraySize); cell++)

| | |
|---|---|
| 33 | { |

| | |
|---|---|
| 34 | unsigned int Diag1 = 2 * P0 + 3; |
| 35 | unsigned int Diag2 = 2 * P0 + n; |
| 36 | unsigned int h = 2 * cell; |
| 37 | unsigned int k = h + n; |
| 38 | unsigned int jrel = 2 * P0 + 1; |
| 39 | unsigned int irel = Diag1 − jrel; |
| 40 | while ((jrel > irel) && (StateNo < |

ArraySize))

| | |
|---|---|
| 41 | { |

| | |
|---|---|
| 42 | PulsePositions[StateNo][0] = h; |
| 43 | PulsePositions[StateNo][1] = |

h+irel;

| | |
|---|---|
| 44 | PulsePositions[StateNo][2] = |

h+jrel;

| | |
|---|---|
| 45 | PulsePositions[StateNo][3] = k; |
| 46 | StateNo++; |
| 47 | jrel −= 2; |
| 48 | irel += 2; |

| | |
|---|---|
| 49 | } |
| 50 | irel = 2 * P0 + 2; |
| 51 | jrel = Diag2 − irel; |
| 52 | while ((irel < jrel) && (StateNo < |

ArraySize))

| | |
|---|---|
| 53 | { |

| | |
|---|---|
| 54 | PulsePositions[StateNo][0] = h; |
| 55 | PulsePositions[StateNo][1] = |

h+irel;

| | |
|---|---|
| 56 | PulsePositions[StateNo][2] = |

h+jrel;

| | |
|---|---|
| 57 | PulsePositions[StateNo][3] = k; |
| 58 | StateNo++; |
| 59 | jrel −= 2; |
| 60 | irel += 2; |

| | |
|---|---|
| 61 | } |
| 62 | P0 = ((P0 − 1 + ijskip) % Pn ) + 1; |

| | |
|---|---|
| 63 | } |

| | |
|---|---|
| 64 | } |

| | |
|---|---|
| 65 | } |

| | |
|---|---|
| 66 | } |
| 67 | return(StateNo); |
| 68 } | |

What is claimed is:

1. A device for radio sensing comprising:
an input-output port for receiving an input radio-frequency signal and for delivering an output radio-frequency signal derived from the input radio-frequency signal;
a plurality of M possible reflector positions, wherein M is a positive integer greater than two and wherein each individual possible reflector position is identified by an integer, h, in the range [1, . . . , M]; and
a plurality of N actual reflectors placed at a subset of the M possible reflector positions, wherein N is a positive integer greater than one and less than M and no two actual reflectors are at the same position, such that each actual reflector is identified by an integer, n, in the range [1, . . . , N] and by a position, h(n), wherein h(n) is a monotonically increasing function of n;
wherein the M possible reflector positions are arranged, relative to the input-output port, to achieve the following:
(i) each actual reflector reflects a portion of the input radio-frequency signal,
(ii) each reflected portion of the input radio-frequency signal comprises a reflected signal that is an reduced-amplitude replica of the input signal, for a total of N reflected signals from the N actual reflectors,
(iii) the N reflected signals arrive at the output port where they are linearly combined to generate the output radio-frequency signal,
(iv) each of the N reflected signals arrives at the input-output port with a group delay and with a phase delay, wherein the group delay and the phase delay depend on the frequency of the input radio-frequency signal, and
(v) for input radio-frequency signals within a pre-determined frequency band, each actual reflector n at possible reflector position h(n) generates a reflected signal with a group delay, D(h(n)), such that D(h) is a monotonically increasing function of h; and
wherein the N positions of the N actual reflectors, h(1) through h(N), satisfy the following constraints:
(a) each of the N−1 separations between adjacent reflected signals, defined as h(m+1)−h(m) and denoted as Δ(m), is the sum of a base value, Δ0(m), and an integer multiple of a position step, Δstep, common to all separations, such that each separation can be expressed as Δ(m)=Δ0(m)+Δinc(m)—Δstep, wherein m is an integer in the range [1, . . . , N−1],
(b) Δ0(m) is a positive integer that defines the minimum allowed value of separation Δ(m),
(c) Δstep is a positive integer greater than one that defines the increment by which separation Δ(m) can be increased, and
(d) Δinc(m) is a non-negative integer.

2. The device of claim 1:
wherein the group delay generated by actual reflector n can be expressed as D(n)=D0+h(n)·Dstep+n·Dcorr, wherein D0 and Dstep are positive values, and Dcorr is such that |Dcorr|<Dstep; and
wherein the phase delay generated by actual reflector n can be expressed as T(n)=T0+h(n)·Tstep+n·Tcorr, wherein T0 and Tstep are positive values, and Tcorr is such that |Tcorr|<Tstep.

3. The device of claim 1 further comprising a piezoelectric substrate;
wherein the input-output port comprises a transducer on the piezoelectric substrate;
wherein the transducer
(i) converts the input radio-frequency signal from an electrical signal to a surface acoustic wave (SAW) signal that travels on the surface of the piezoelectric substrate,
(ii) converts the output radio-frequency signal from a SAW signal that travels on the surface of the piezoelectric substrate to an electrical signal; and
wherein the M possible reflector positions are arranged in a linear sequence on the surface of the piezoelectric substrate.

4. The device of claim 3:
wherein the M possible reflector positions are evenly spaced; and
wherein for input radio-frequency signals within the pre-determined frequency band, two actual reflectors at consecutive possible reflector positions h and h+1 generate reflected signals whose phase delays differ from one another by a predetermined value, Tstep, which is the same for all values of h.

5. The device of claim 4 wherein N has the value 4.

6. The device of claim 5:
wherein the 4 positions of the 4 actual reflectors, h(1) through h(4), also satisfy the following additional constraints:
(e) Δ0(1) is even,
(f) Δ0(2) is odd,
(g) Δ0(3) is even,
(h) Δstep has the value 2,
(i) h(1)+h(4)≠h(2)+h(3);

7. The device of claim 1:
wherein N has the value 4; and
wherein the 4 positions of the 4 actual reflectors, h(1) through h(4), also satisfy the following additional constraints:
(e) Δ0(1) is even,
(f) Δ0(2) is odd,
(g) Δ0(3) is even,
(h) Δstep has the value 2,
(i) h(1)+h(4)≠h(2)+h(3);

8. The device of claim 1:
wherein N has the value 4; and
wherein the 4 positions of the 4 actual reflectors, h(1) through h(4), also satisfy the following additional constraints:
(a) Δ0(1) is odd,
(b) Δ0(2) is even,
(c) Δ0(3) is even,
(d) Δstep has the value 2,
(e) h(2)+h(4)≠2·h(3);

9. The device of claim 1:
wherein N has the value 4; and
wherein the 4 positions of the 4 actual reflectors, h(1) through h(4), also satisfy the following additional constraints:
(a) Δ0(1) is even,
(b) Δ0(2) is even,
(c) Δ0(3) is odd,
(d) Δstep has the value 2,
(e) h(1)+h(3)≠2·h(2);

10. The device of claim 1:
wherein N has the value 4; and
wherein the 4 positions of the 4 actual reflectors, h(1) through h(4), also satisfy the following additional constraints:
(a) Δ0(1) is odd,
(b) Δ0(2) is odd,
(c) Δ0(3) is even,
(d) Δstep has the value 2,
(e) h(1)+h(3)≠2·h(2),
(f) h(1)+h(4)≠2·h(2),
(g) h(1)+h(4)≠2·h(3);

11. The device of claim 1:
wherein N has the value 4; and
wherein the 4 positions of the 4 actual reflectors, h(1) through h(4), also satisfy the following additional constraints:
(a) Δ0(1) is even,
(b) Δ0(2) is odd,
(c) Δ0(3) is odd,
(d) Δstep has the value 2,
(e) h(2)+h(4)≠2·h(3),
(f) h(1)+h(4)≠2·h(2),
(g) h(1)+h(4)≠2·h(3);

12. The device of claim 1:
wherein N has the value 4; and
wherein the 4 positions of the 4 actual reflectors, h(1) through h(4), also satisfy the following additional constraints:
(a) Δ0(1) is odd,
(b) Δ0(2) is even,
(c) Δ0(3) is odd,
(d) Δstep has the value 2,
(e) h(1)+h(4)≠h(2)+h(3),
(f) h(1)+h(4)≠2·h(2),
(g) h(1)+h(4)≠2·h(3);

13. The device of claim 1:
wherein N has the value 4; and
wherein the 4 positions of the 4 actual reflectors, h(1) through h(4), also satisfy the following additional constraints:
(a) Δ0(1) is odd,
(b) Δ0(2) is odd,
(c) Δ0(3) is odd,
(d) Δstep has the value 2,
(e) h(1)+h(3)≠2·h(2),
(f) h(2)+h(4)≠2·h(3),
(g) h(1)+h(4)≠h(2)+h(3);

14. A system for radio sensing comprising:
a plurality of radio sensing devices wherein each device comprises:
(A) an input-output port for receiving an input radio-frequency signal and for delivering an output radio-frequency signal derived from the input radio-frequency signal;
(B) a plurality of N actual reflectors, wherein N is a positive integer greater than one that is the same for all radio sensing devices;
wherein each of the N actual reflectors is positioned, within each device, at one of a plurality of M possible reflector positions, wherein
(1) M is a positive integer greater than N that is the same for all radio sensing devices,
(2) the plurality of M possible reflector positions is the same for all the radio sensing devices, and
(3) each individual possible reflector position is identified by an integer, h, in the range [1, . . . , M];
wherein the N actual reflectors are placed at a subset of the M possible reflector positions, with no two actual reflectors at the same position, such that each actual reflector is identified by an integer, n, in the range [1, . . . , N] and by a position, h(n), wherein h(n) is a monotonically increasing function of n;
wherein the M possible reflector positions are arranged, relative to the input-output port, to achieve the following:
(i) each actual reflector reflects a portion of the input radio-frequency signal,
(ii) each reflected portion of the input radio-frequency signal comprises a reflected signal that is an reduced-amplitude replica of the input signal, for a total of N reflected signals from the N actual reflectors,
(iii) the N reflected signals arrive at the output port where they are linearly combined to generate the output radio-frequency signal,
(iv) each of the N reflected signals arrives at the input-output port with a group delay and with a phase delay, wherein the group delay and the phase delay depend on the frequency of the input radio-frequency signal, and
(v) for input radio-frequency signals within a pre-determined frequency band, each actual reflector n at possible reflector position h(n) generates a reflected signal with a group delay, D(h(n)), such that D(h) is a monotonically increasing function of h; and
wherein the N positions of the N actual reflectors, h(1) through h(N), satisfy the following constraints:
(a) each of the N−1 separations between adjacent reflected signals, defined as h(m+1)-h(m) and denoted as Δ(m), is the sum of a base value, Δ0(m), and an integer multiple of a position step, Δstep, common to all separations, such that each separation can be expressed as Δ(m)=Δ0(m)+Δinc(m)·Δstep, wherein m is an integer in the range [1, . . . , N−1],
(b) Δ0(m) is a positive integer that defines the minimum allowed value of separation Δ(m),
(c) Δstep is a positive integer greater than one that defines the increment by which separation Δ(m) can be increased,
(d) Δinc(m) is a non-negative integer
(e) the values of Δ0(m), for all values of m in the range [1, . . . , N−1], and the value of
Δstep are the same for all radio sensing devices, and
(f) no two radio sensing devices in the plurality of radio sensing devices have the same set of values for h(1) through h(N).

15. The device of claim 14:
wherein the group delay generated by actual reflector n can be expressed as D(n)=D0+h(n)·Dstep+n·Dcorr, wherein D0 and Dstep are positive values, and Dcorr is such that |Dcorr|<Dstep; and
wherein the phase delay generated by actual reflector n can be expressed as T(n)=T0+h(n)·Tstep+n·Tcorr, wherein T0 and Tstep are positive values, and Tcorr is such that |Tcorr|<Tstep.

16. The system of claim 14
wherein each of the plurality of radio sensing devices further comprises a piezoelectric substrate;
wherein the input-output port comprises a transducer on the piezoelectric substrate;
wherein the transducer
(i) converts the input radio-frequency signal from an electrical signal to a surface acoustic wave (SAW) signal that travels on the surface of the piezoelectric substrate,
(ii) converts the output radio-frequency signal from a SAW signal that travels on the surface of the piezoelectric substrate to an electrical signal; and
wherein the M possible reflector positions are arranged in a linear sequence on the surface of the piezoelectric substrate.

17. The system of claim 16:
wherein the M possible reflector positions are evenly spaced; and
wherein for input radio-frequency signals within the pre-determined frequency band, two actual reflectors at consecutive possible reflector positions h and h+1 generate reflected signals whose phase delays differ from one another by a predetermined value, Tstep, which is the same for all values of h and for all radio sensing devices.

18. The system of claim 17 wherein N has the value 4.

19. The system of claim 18:
wherein the 4 positions of the 4 actual reflectors, h(1) through h(4), also satisfy the following additional constraints:
(e) Δ0(1) is even,
(f) Δ0(2) is odd,
(g) Δ0(3) is even,
(h) Δstep has the value 2,
(i) h(1)+h(4)≠h(2)+h(3).

20. The system of claim 19 wherein the number of radio sensing devices comprising an actual reflector at position h does not exceed a fraction of the total number of radio sensing devices in the system equal to (N/M)·(1+p), wherein p is a pre-determined value.

21. The system of claim 14:
wherein N has the value 4; and
wherein the 4 positions of the 4 actual reflectors, h(1) through h(4), also satisfy the following additional constraints:
(e) Δ0(1) is even,
(f) Δ0(2) is odd,
(g) Δ0(3) is even,
(h) Δstep has the value 2,
(i) h(1)+h(4)≠h(2)+h(3).

22. The device of claim 14:
wherein N has the value 4; and
wherein the 4 positions of the 4 actual reflectors, h(1) through h(4), also satisfy the following additional constraints:
(a) Δ0(1) is odd,
(b) Δ0(2) is even,
(c) Δ0(3) is even,
(d) Δstep has the value 2,
(e) h(2)+h(4)≠2·h(3);

23. The device of claim 14:
wherein N has the value 4; and
wherein the 4 positions of the 4 actual reflectors, h(1) through h(4), also satisfy the following additional constraints:
(a) Δ0(1) is even,
(b) Δ0(2) is even,
(c) Δ0(3) is odd,
(d) Δstep has the value 2,
(e) h(1)+h(3)≠2·h(2);

24. The device of claim 14:
wherein N has the value 4; and
wherein the 4 positions of the 4 actual reflectors, h(1) through h(4), also satisfy the following additional constraints:
(a) Δ0(1) is odd,
(b) Δ0(2) is odd,
(c) Δ0(3) is even,
(d) Δstep has the value 2,
(e) h(1)+h(3)≠2·h(2),
(f) h(1)+h(4)≠2·h(2),
(g) h(1)+h(4)≠2·h(3);

25. The device of claim 14:
wherein N has the value 4; and
wherein the 4 positions of the 4 actual reflectors, h(1) through h(4), also satisfy the following additional constraints:
(a) Δ0(1) is even,
(b) Δ0(2) is odd,
(c) Δ0(3) is odd,
(d) Δstep has the value 2,
(e) h(2)+h(4)≠2·h(3),
(f) h(1)+h(4)≠2·h(2),
(g) h(1)+h(4)≠2·h(3);

26. The device of claim 14:
wherein N has the value 4; and
wherein the 4 positions of the 4 actual reflectors, h(1) through h(4), also satisfy the following additional constraints:
(a) Δ0(1) is odd,
(b) Δ0(2) is even,
(c) Δ0(3) is odd,
(d) Δstep has the value 2,
(e) h(1)+h(4)≠h(2)+h(3),
(f) h(1)+h(4)≠2·h(2),
(g) h(1)+h(4)≠2·h(3);

27. The device of claim 14:
wherein N has the value 4; and
wherein the 4 positions of the 4 actual reflectors, h(1) through h(4), also satisfy the following additional constraints:
(a) Δ0(1) is odd,
(b) Δ0(2) is odd,
(c) Δ0(3) is odd,
(d) Δstep has the value 2,
(e) h(1)+h(3)≠2·h(2),
(f) h(2)+h(4)≠2·h(3),
(g) h(1)+h(4)≠h(2)+h(3);

28. The system of claim 14 wherein the number of radio sensing devices comprising an actual reflector at position h does not exceed a fraction of the total number of radio sensing devices in the system equal to (N/M)·(1+p), wherein p is a pre-determined value.

29. A method comprising:
fabricating L radio-frequency (RFID) devices, wherein L is a positive integer greater than one;
wherein each of the L radio-frequency devices comprises N actual reflectors in M possible reflector positions;
wherein at least C of the positions of the N actual reflectors in each of the L radio-frequency (RFID) devices are different from the positions of the N actual reflectors in each of the other L−1 radio-frequency (RFID) devices, wherein C is a positive integer greater than one;
wherein each device comprises:
(A) an input-output port for receiving an input radio-frequency signal and for delivering an output radio-frequency signal derived from the input radio-frequency signal;
(B) a plurality of N actual reflectors, wherein N is a positive integer greater than one that is the same for all RFID devices;
wherein each of the N actual reflectors is positioned, within each device, at one of a plurality of M possible reflector positions, wherein
(1) M is a positive integer greater than N that is the same for all RFID devices,
(2) the plurality of M possible reflector positions is the same for all the RFID devices, and
(3) each individual possible reflector position is identified by an integer, h, in the range [1, . . . , M];
wherein the N actual reflectors are placed at a subset of the M possible reflector positions, with no two actual reflectors at the same position, such that each actual reflector is identified by an integer, n, in the range [1, . . . , N] and by a position, h(n);
wherein the M possible reflector positions are arranged, relative to the input-output port, to achieve the following:
(i) each actual reflector reflects a portion of the input radio-frequency signal,
(ii) each reflected portion of the input radio-frequency signal comprises a reflected signal that is an attenuated replica of the input signal, for a total of N reflected signals from the N actual reflectors,
(iii) the N reflected signals arrive at the output port where they are linearly combined to generate the output radio-frequency signal,
(iv) each of the N reflected signals arrives at the input-output port with a group delay and with a phase delay, wherein the group delay and the phase delay depend on the frequency of the input radio-frequency signal, and
(v) for input radio-frequency signals within a pre-determined frequency band, actual reflector n at possible reflector position h(n) generates a reflected signal whose group delay, D(h(n)), is a monotonically increasing function of h(n);
wherein the N positions of the N actual reflectors, h(1) through h(N), satisfy the following constraints:
(a) each of the N−1 separations between adjacent reflected signals, defined as h(m+1)-h(m) and denoted as Δ(m), is the sum of a base value, Δ0(m), and an integer multiple of a position step, Δstep, common to all separations, such that each separation can be expressed as Δ(m)=Δ0(m)+Δinc(m)·Δstep, wherein m is an integer in the range [1, . . . , N−1],
(b) Δ0(m) is a positive integer that defines the minimum allowed value of separation m,
(c) Δstep is a positive integer greater than one that defines the increment by which separation m can be increased,
(d) Δinc(m) is a non-negative integer
(e) the values of Δ0(m), for all values of m in the range [1, . . . , N−1], and the value of
Δstep are the same for all RFID devices, and
(f) no two RFID devices in the plurality of RFID devices have the same set of values for h(1) through h(N).

30. The method of claim 29 wherein C is a function of L.

31. The method of claim 29 wherein C is 3.

32. A method comprising:
fabricating L radio-frequency (RFID) devices, wherein L is a positive integer greater than one;
wherein each of the L radio-frequency devices comprises N actual reflectors in M possible reflector positions;
wherein the positions of the N actual reflectors in each of the L radio-frequency (RFID) devices are different from the positions of the N actual reflectors in each of the other L−1 radio-frequency (RFID) devices according to a rule;
wherein each device comprises:
(A) an input-output port for receiving an input radio-frequency signal and for delivering an output radio-frequency signal derived from the input radio-frequency signal;
(B) a plurality of N actual reflectors, wherein N is a positive integer greater than one that is the same for all RFID devices;
wherein each of the N actual reflectors is positioned, within each device, at one of a plurality of M possible reflector positions, wherein
(1) M is a positive integer greater than N that is the same for all RFID devices,
(2) the plurality of M possible reflector positions is the same for all the RFID devices, and
(3) each individual possible reflector position is identified by an integer, h, in the range [1, . . . , M];
wherein the N actual reflectors are placed at a subset of the M possible reflector positions, with no two actual reflectors at the same position, such that each actual reflector is identified by an integer, n, in the range [1, . . . , N] and by a position, h(n);
wherein the M possible reflector positions are arranged, relative to the input-output port, to achieve the following:
(i) each actual reflector reflects a portion of the input radio-frequency signal,
(ii) each reflected portion of the input radio-frequency signal comprises a reflected signal that is an attenuated replica of the input signal, for a total of N reflected signals from the N actual reflectors,
(iii) the N reflected signals arrive at the output port where they are linearly combined to generate the output radio-frequency signal,
(iv) each of the N reflected signals arrives at the input-output port with a group delay and with a phase delay, wherein the group delay and the phase delay depend on the frequency of the input radio-frequency signal, and
(v) for input radio-frequency signals within a pre-determined frequency band, actual reflector n at possible reflector position h(n) generates a reflected signal whose group delay, D(h(n)), is a monotonically increasing function of h(n);
wherein the N positions of the N actual reflectors, h(1) through h(N), satisfy the following constraints:
(a) each of the N−1 separations between adjacent reflected signals, defined as h(m+1)-h(m) and denoted as Δ(m), is the sum of a base value, Δ0(m), and an integer multiple of a position step, Δstep, common to all separations, such that each separation can be expressed as Δ(m)=Δ0(m)+Δinc(m)·Δstep, wherein m is an integer in the range [1, . . . , N−1],
(b) Δ0(m) is a positive integer that defines the minimum allowed value of separation m,
(c) Δstep is a positive integer greater than one that defines the increment by which separation m can be increased,
(d) Δinc(m) is a non-negative integer
(e) the values of Δ0(m), for all values of m in the range [1, . . . , N−1], and the value of Δstep are the same for all RFID devices, and
(f) no two RFID devices in the plurality of RFID devices have the same set of values for h(1) through h(N).

33. The method of claim 32 wherein the rule is wherein at least C of the positions of the N actual reflectors in each of the L radio-frequency (RFID) devices are different from the positions of the N actual reflectors in each of the other L−1 radio-frequency (RFID) devices, wherein C is a positive integer greater than one.

34. The method of claim 32 wherein C is a function of L.

35. The method of claim 32 wherein C is 3.

36. The method of claim 32 wherein the rule is wherein at least C of the positions of the N actual reflectors in each of the L radio-frequency (RFID) devices are at least Z positions from the positions of the N actual reflectors in each of the other L−1 radio-frequency (RFID) devices, wherein C is a positive integer greater than one, and wherein Z is a positive integer.

37. The method of claim 32 wherein Z is a function of L.

38. The method of claim 32 wherein Z is 2.
